(19) United States
(12) Patent Application Publication
(10) Pub. No.: US 2024/0195319 A1
(43) Pub. Date: Jun. 13, 2024

(54) APPARATUS FOR APPLYING PULSES AND PULSE EDGES TO A RESONANT CIRCUIT

(71) Applicant: NICOVENTURES TRADING LIMITED, London (GB)

(72) Inventor: Anton KORUS, Derby (GB)

(21) Appl. No.: 18/254,704

(22) PCT Filed: Nov. 30, 2021
(86) PCT No.: PCT/GB2021/053112

§ 371 Date: May 26, 2023

(30) Foreign Application Priority Data
Dec. 1, 2020 (GB) 2018939.5

(51) Int. Cl. H02M 7/48; A24F 40/20; A24F 40/465; H02M 7/5387

(52) U.S. Cl. CPC H02M 7/4815; A24F 40/20; A24F 40/465; H02M 7/5387

(57) ABSTRACT

An apparatus can include a bridge circuit for applying one or more pulse edges to a resonant circuit, the bridge circuit having a first limb in which a first connection point is connected to ground, and a second limb having a third transistor connected between a first power source and a second connection point and a fourth transistor connected between the second connection point and ground, wherein the resonant circuit can include an inductive element and a capacitor connected in series between the first and second connection points, wherein the inductive element is for inductively heating a susceptor, wherein each applied pulse edge induces a pulse response between the capacitor and the inductive element of the resonant circuit, wherein the pulse response has a resonant frequency.

### PRIORITY CLAIM

The present application is a National Phase entry of PCT Application No. PCT/GB2021/053112, filed Nov. 30, 2021, which claims priority from GB Application No. 2018939.5, filed Dec. 1, 2020, each of which is hereby fully incorporated herein by reference.

### TECHNICAL FIELD

The present specification relates to an apparatus for applying pulses and pulse edges to a resonant circuit (for example as part of an aerosol generating device) and a method for controlling such an apparatus.

### BACKGROUND

Smoking articles, such as cigarettes, cigars and the like burn tobacco during use to create tobacco smoke. Attempts have been made to provide alternatives to these articles by creating products that release compounds without combusting. For example, tobacco heating devices heat an aerosol generating substrate such as tobacco to form an aerosol by heating, but not burning, the substrate.

### SUMMARY

In a first aspect, this specification describes an apparatus comprising: a bridge circuit for applying one or more pulse edges to a resonant circuit, the bridge circuit (such as an H-bridge circuit) having a first limb in which a first connection point is connected to ground, and a second limb having a third transistor connected between a first power source and a second connection point and a fourth transistor connected between the second connection point and ground, wherein the resonant circuit comprises an inductive element and a capacitor connected in series between the first and second connection points, wherein the inductive element is for inductively heating a susceptor, wherein each applied pulse edge induces a pulse response between the capacitor and the inductive element of the resonant circuit, wherein the pulse response has a resonant frequency. The apparatus may further comprise said resonant circuit.

The first limb of the bridge circuit may comprise a first transistor connected between the first power source and the first connection point.

The first limb of the bridge circuit comprises a second transistor connected between the first connection point and ground.

The capacitor of the resonant circuit may be connected to the first connection point. The inductive element of the resonant circuit may be connected to the second connection point.

Some example embodiments further comprise an output connection point between the inductive element and the capacitor of the resonant circuit. An output circuit (such as a DC voltage adjustment circuit) may be coupled (e.g. using an output capacitor) to the output connection point between the inductive element and the capacitor of the resonant circuit. The capacitor of the resonant circuit may be provided between the first connection point and the output connection point and the inductive element of the resonant circuit is provided between the second connection point and the output connection point. The output circuit may comprise a comparator.

In a second aspect, this specification describes an apparatus comprising: an H-bridge circuit for applying one or more pulse edges to a resonant circuit, the H-bridge circuit having a first limb having a first transistor connected between a first power source and a first connection point and a second transistor connected between the first connection point and ground, and a second limb having a third transistor connected between the first power source and a second connection point and a fourth transistor connected between the second connection point and ground, wherein the resonant circuit comprises an inductive element and a capacitor connected in series between the first and second connection points, wherein the inductive element is for inductively heating a susceptor, wherein each applied pulse edge induces a pulse response between the capacitor and the inductive element of the resonant circuit, wherein the pulse response has a resonant frequency; an output circuit for providing an output signal dependent on one or more properties of the pulse response; and an output capacitor connected between an output connection point between the inductive element and the capacitor of the resonant circuit and an input of the output circuit. The apparatus may further comprise said resonant circuit. The capacitor of the resonant circuit may be provided between the first connection point and the output connection point. The inductive element of the resonant circuit may be provided between the second connection point and the output connection point. The output circuit may comprise a DC voltage adjustment circuit. The output circuit may comprise a comparator.

The apparatus of either the first aspect or the second aspect may be operable in a heating mode of operation in which one or more pulses are applied to the inductive element for inductively heating the susceptor.

In a third aspect, this specification describes a method comprising: selecting between a measurement mode and a heating mode of operation of a resonant circuit, wherein the resonant circuit comprises an inductive element and a capacitor connected in series between first and second connection points of a bridge circuit; and configuring the bridge circuit in a half-bridge mode in the event that the measurement mode is selected and configuring the bridge circuit in a full-bridge mode in the event that the heating mode of operation is selected, wherein the bridge circuit comprises a first limb having the first connection point, a second limb having the second connection point, a third transistor connected between a first power source and the second connection point and the fourth transistor connected between the second connection point and ground.

Configuring the bridge circuit in the half-bridge mode may comprise configuring the bridge circuit such that the first connection point is connected to ground. The half-bridge mode may be implemented by switching the third and fourth transistors forming the second limb.

The first limb may comprise a second transistor connected between the first connection point and ground. Configuring the bridge circuit in the half-bridge mode may comprise switching a second transistor (that is connected between the first connection point and ground) into a conducting state.

The first limb may comprise a first transistor connected between the first power source and the first connection point and a second transistor connected between the first connection point and ground.

The method may further comprise applying one or more pulse edges to the resonant circuit in the measurement mode of operation, wherein each applied pulse edge induces a pulse response between the capacitor and the inductive element of the resonant circuit, wherein the pulse response has a resonant frequency.

The method may further comprise applying one or more pulses to the inductive element for inductively heating a susceptor in the heating mode of operation.

In a fourth aspect, this specification describes a non-combustible aerosol generating device comprising an apparatus as described above with reference to the first or second aspects. The aerosol generating device may be configured to receive a removable article comprising an aerosol generating material. The aerosol generating material may, for example, comprise an aerosol generating substrate and an aerosol forming material. The removable article may include a susceptor arrangement.

In a fifth aspect, this specification describes a kit of parts comprising an article for use in a non-combustible aerosol generating system, wherein the non-combustible aerosol generating system comprises an apparatus as described above with reference to the first or second aspects or an aerosol generating device as described above with reference to the fourth aspect. The article may be a removable article comprising an aerosol generating material.

### BRIEF DESCRIPTION OF THE DRAWINGS

Example embodiments will now be described, by way of example only, with reference to the following schematic drawings, in which:

FIG. 1 is a block diagram of a system in accordance with an example embodiment.

FIG. 2 shows a non-combustible aerosol provision device in accordance with an example embodiment.

FIG. 3 is a view of a non-combustible aerosol provision device in accordance with an example embodiment.

FIG. 4 is a view of an article for use with a non-combustible aerosol provision device in accordance with an example embodiment.

FIG. 5 is a block diagram of a circuit in accordance with an example embodiment.

FIG. 6 shows a resonant circuit in accordance with an example embodiment.

FIG. 7 is a block diagram of a circuit in accordance with an example embodiment.

FIG. 8 is a block diagram of a system in accordance with an example embodiment.

FIG. 9 is a block diagram of a circuit in accordance with an example embodiment.

FIG. 10 is a flow chart showing an algorithm in accordance with an example embodiment.

FIGS. 11 and 12 are plots demonstrating example uses of example embodiments.

FIGS. 13 and 14 are block diagrams of circuits in accordance with example embodiments.

FIG. 15 is a flow chart showing an algorithm in accordance with an example embodiment.

### DETAILED DESCRIPTION OF THE DRAWINGS

As used herein, the term “aerosol delivery device” is intended to encompass systems that deliver a substance to a user, and includes:
non-combustible aerosol provision systems that release compounds from an aerosolizable material without combusting the aerosolizable material, such as electronic cigarettes, tobacco heating products, and hybrid systems to generate aerosol using a combination of aerosolizable materials; and
articles comprising aerosolizable material and configured to be used in one of these non-combustible aerosol provision systems.

According to the present disclosure, a “combustible” aerosol provision system is one where a constituent aerosolizable material of the aerosol provision system (or component thereof) is combusted or burned in order to facilitate delivery to a user.

According to the present disclosure, a “non-combustible” aerosol provision system is one where a constituent aerosolizable material of the aerosol provision system (or component thereof) is not combusted or burned in order to facilitate delivery to a user.

In embodiments described herein, the delivery system is a non-combustible aerosol provision system, such as a powered non-combustible aerosol provision system.

In one embodiment, the non-combustible aerosol provision system is an electronic cigarette, also known as a vaping device or electronic nicotine delivery system (END), although it is noted that the presence of nicotine in the aerosolizable material is not a requirement.

In one embodiment, the non-combustible aerosol provision system is a tobacco heating system, also known as a heat-not-burn system.

In one embodiment, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In one embodiment, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision system. However, it is envisaged that articles which themselves comprise a means for powering an aerosol generating component may themselves form the non-combustible aerosol provision system.

In one embodiment, the non-combustible aerosol provision device may comprise a power source and a controller. The power source may be an electric power source or an exothermic power source. In one embodiment, the exothermic power source comprises a carbon substrate which may be energized so as to distribute power in the form of heat to an aerosolizable material or heat transfer material in proximity to the exothermic power source. In one embodiment, the power source, such as an exothermic power source, is provided in the article so as to form the non-combustible aerosol provision.

In one embodiment, the article for use with the non-combustible aerosol provision device may comprise an aerosolizable material, an aerosol generating component, an aerosol generating area, a mouthpiece, and/or an area for receiving aerosolizable material.

In one embodiment, the aerosol generating component is a heater capable of interacting with the aerosolizable material so as to release one or more volatiles from the aerosolizable material to form an aerosol. In one embodiment, the aerosol generating component is capable of generating an aerosol from the aerosolizable material without heating. For example, the aerosol generating component may be capable of generating an aerosol from the aerosolizable material without applying heat thereto, for example via one or more of vibrational, mechanical, pressurization or electrostatic means.

In one embodiment, the aerosolizable material may comprise an active material, an aerosol forming material and optionally one or more functional materials. The active material may comprise nicotine (optionally contained in tobacco or a tobacco derivative) or one or more other non-olfactory physiologically active materials. A non-olfactory physiologically active material is a material which is included in the aerosolizable material in order to achieve a physiological response other than olfactory perception. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. In some embodiments, the active substance comprises nicotine. In some embodiments, the active substance comprises caffeine, melatonin or vitamin B12.

The aerosol forming material may comprise one or more of glycerine, glycerol,propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more functional materials may comprise one or more of flavors, carriers, pH regulators, stabilizers, and/or antioxidants.

In one embodiment, the article for use with the non-combustible aerosol provision device may comprise aerosolizable material or an area for receiving aerosolizable material. In one embodiment, the article for use with the non-combustible aerosol provision device may comprise a mouthpiece. The area for receiving aerosolizable material may be a storage area for storing aerosolizable material. For example, the storage area may be a reservoir. In one embodiment, the area for receiving aerosolizable material may be separate from, or combined with, an aerosol generating area.

Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it.

The aerosolizable material may be present on a substrate. The substrate may, for example, be or comprise paper, card, paperboard, cardboard, reconstituted aerosolizable material, a plastics material, a ceramic material, a composite material, glass, a metal, or a metal alloy.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

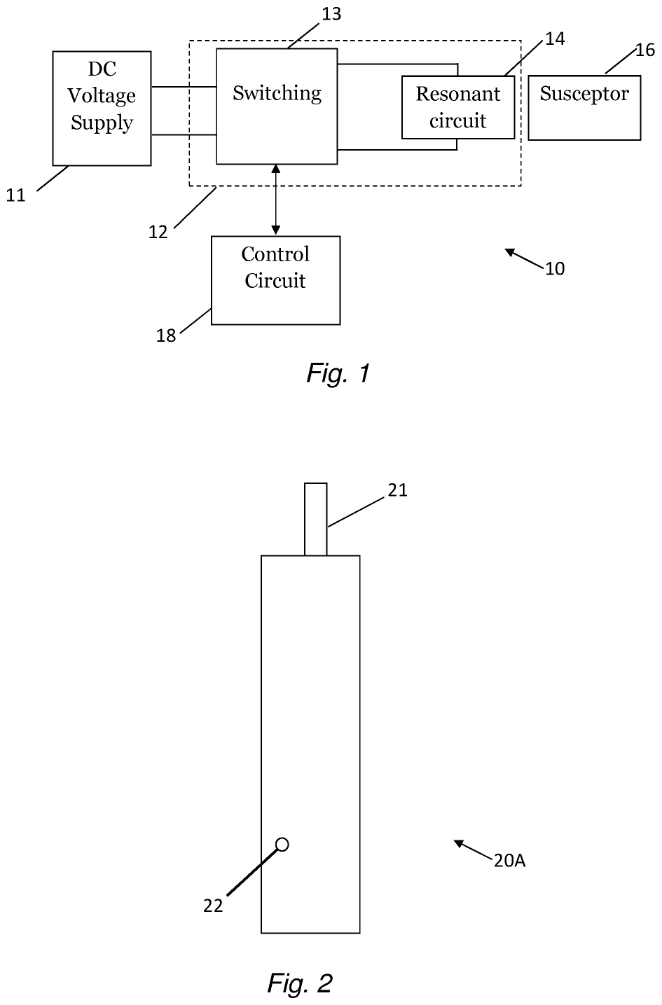

FIG. 1 is a block diagram of a system, indicated generally by the reference numeral 10, in accordance with an example embodiment. The system 10 comprises a power source in the form of a direct current (DC) voltage supply 11, a switching arrangement 13, a resonant circuit 14, a susceptor arrangement 16, and a control circuit 18. The switching arrangement 13 and the resonant circuit 14 may be coupled together in an inductive heating arrangement 12 that can be used to heat the susceptor 16.

As discussed in detail below, the resonant circuit 14 may comprise a capacitor and one or more inductive elements for inductively heating the susceptor arrangement 16 to heat an aerosol generating material. Heating the aerosol generating material may thereby generate an aerosol.

The switching arrangement 13 may enable an alternating current to be generated from the DC voltage supply 11 (under the control of the control circuit 18). The alternating current may flow through the one or more inductive elements and may cause the heating of the susceptor arrangement 16. The switching arrangement may comprise a plurality of transistors. Example DC-AC converters include H-bridge or inverter circuits, examples of which are discussed below.

A susceptor is a material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

In one embodiment, the susceptor is in the form of a closed circuit. It has been found in some embodiments that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

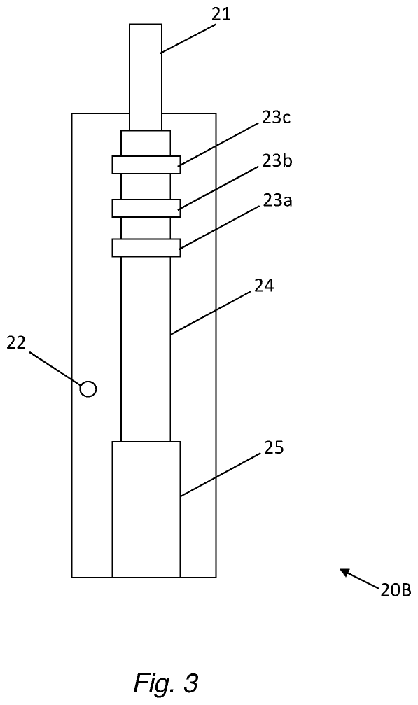

FIGS. 2 and 3 show a non-combustible aerosol provision device, indicated generally by the reference numeral 20, in accordance with an example embodiment. FIG. 2 is a perspective illustration of an aerosol provision device 20A with an outer cover. The aerosol provision device 20A may comprise a replaceable article 21 that may be inserted in the aerosol provision device 20A to enable heating of a susceptor (which may be comprised within the article 21, as discussed further below). The aerosol provision device 20A may further comprise an activation switch 22 that may be used for switching on or switching off the aerosol provision device 20A.

FIG. 3 depicts an aerosol provision device 20B with the outer cover removed. The aerosol generating device 20B comprises the article 21, the activation switch 22, a plurality of inductive elements 23a, 23b, and 23c, and one or more air tube extenders 24 and 25. The one or more air tube extenders 24 and 25 may be optional.

The plurality of inductive elements 23a, 23b, and 23c may each form part of a resonant circuit, such as the resonant circuit 14. The inductive element 23a may comprise a helical inductor coil. In one example, the helical inductor coil is made from Litz wire/cable which is wound in a helical fashion to provide the helical inductor coil. Many alternative inductor formations are possible, such as inductors formed within a printed circuit board. The inductive elements 23b and 23c may be similar to the inductive element 23a. The use of three inductive elements 23a, 23b and 23c is not essential to all example embodiments. Thus, the aerosol generating device 20 may comprise one or more inductive elements.

A susceptor may be provided as part of the article 21. In an example embodiment, when the article 21 is inserted in aerosol generating device 20, the aerosol generating device 20 may be turned on due to the insertion of the article 21. This may be due to detecting the presence of the article 21 in the aerosol generating device using an appropriate sensor (e.g., a light sensor) or, in cases where the susceptor forms a part of the article 21, by detecting the presence of the susceptor using the resonant circuit 14, for example. When the aerosol generating device 20 is turned on, the inductive elements 23 may cause the article 21 to be inductively heated through the susceptor. In an alternative embodiment, the susceptor may be provided as part of the aerosol generating device 20 (e.g. as part of a holder for receiving the article 21).

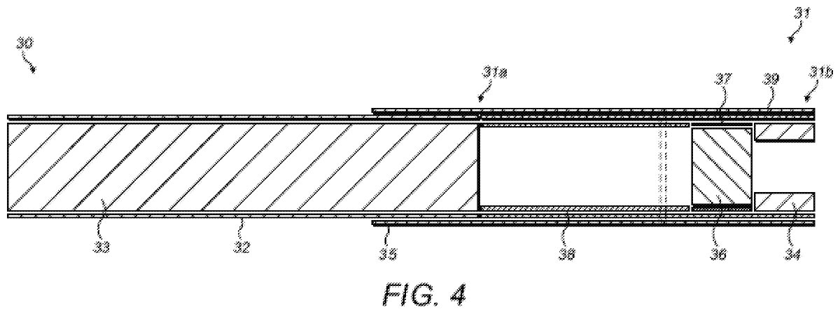

FIG. 4 is a view of an article, indicated generally by the reference numeral 30, for use with a non-combustible aerosol provision device in accordance with an example embodiment. The article 30 is an example of the replaceable article 21 described above with reference to FIGS. 2 and 3.

The article 30 comprises a mouthpiece 31, and a cylindrical rod of aerosol generating material 33, in the present case tobacco material, connected to the mouthpiece 31. The aerosol generating material 33 provides an aerosol when heated, for instance within a non-combustible aerosol generating device, such as the aerosol generating device 20, as described herein. The aerosol generating material 33 is wrapped in a wrapper 32. The wrapper 32 can, for instance, be a paper or paper-backed foil wrapper. The wrapper 32 may be substantially impermeable to air.

In one embodiment, the wrapper 32 comprises aluminum foil. Aluminum foil has been found to be particularly effective at enhancing the formation of aerosol within the aerosol generating material 33. In one example, the aluminum foil has a metal layer having a thickness of about 6 μm. The aluminum foil may have a paper backing. However, in alternative arrangements, the aluminum foil can have other thicknesses, for instance between 4 μm and 16 μm in thickness. The aluminum foil also need not have a paper backing, but could have a backing formed from other materials, for instance to help provide an appropriate tensile strength to the foil, or it could have no backing material. Metallic layers or foils other than aluminum can also be used. Moreover, it is not essential that such metallic layers are provided as part of the article 30; for example, such a metallic layer could be provided as part of the apparatus 20.

The aerosol generating material 33, also referred to herein as an aerosol generating substrate 33, comprises at least one aerosol forming material. In the present example, the aerosol forming material is glycerol. In alternative examples, the aerosol forming material can be another material as described herein or a combination thereof. The aerosol forming material has been found to improve the sensory performance of the article, by helping to transfer compounds such as flavor compounds from the aerosol generating material to the consumer.

As shown in FIG. 4, the mouthpiece 31 of the article 30 comprises an upstream end 31a adjacent to an aerosol generating substrate 33 and a downstream end 31b distal from the aerosol generating substrate 33. The aerosol generating substrate may comprise tobacco, although alternatives are possible.

The mouthpiece 31, in the present example, includes a body of material 36 upstream of a hollow tubular element 34, in this example adjacent to and in an abutting relationship with the hollow tubular element 34. The body of material 36 and hollow tubular element 34 each define a substantially cylindrical overall outer shape and share a common longitudinal axis. The body of material 36 is wrapped in a first plug wrap 37. The first plug wrap 37 may have a basis weight of less than 50 gsm, such as between about 20 gsm and 40 gsm.

In the present example the hollow tubular element 34 is a first hollow tubular element 34 and the mouthpiece includes a second hollow tubular element 38, also referred to as a cooling element, upstream of the first hollow tubular element 34. In the present example, the second hollow tubular element 38 is upstream of, adjacent to and in an abutting relationship with the body of material 36. The body of material 36 and second hollow tubular element 38 each define a substantially cylindrical overall outer shape and share a common longitudinal axis. The second hollow tubular element 38 is formed from a plurality of layers of paper which are parallel wound, with butted seams, to form the tubular element 38. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, molded or extruded plastic tubes or similar. The second hollow tubular element 38 can also be formed using a stiff plug wrap and/or tipping paper as the second plug wrap 39 and/or tipping paper 35 described herein, meaning that a separate tubular element is not required.

The second hollow tubular element 38 is located around and defines an air gap within the mouthpiece 31 which acts as a cooling segment. The air gap provides a chamber through which heated volatilized components generated by the aerosol generating material 33 may flow. The second hollow tubular element 38 is hollow to provide a chamber for aerosol accumulation yet rigid enough to withstand axial compressive forces and bending moments that might arise during manufacture and whilst the article 21 is in use. The second hollow tubular element 38 provides a physical displacement between the aerosol generating material 33 and the body of material 36. The physical displacement provided by the second hollow tubular element 38 will provide a thermal gradient across the length of the second hollow tubular element 38.

Of course, the article 30 is provided by way of example only. The skilled person will be aware of many alternative arrangements of such an article that could be used in the systems described herein.

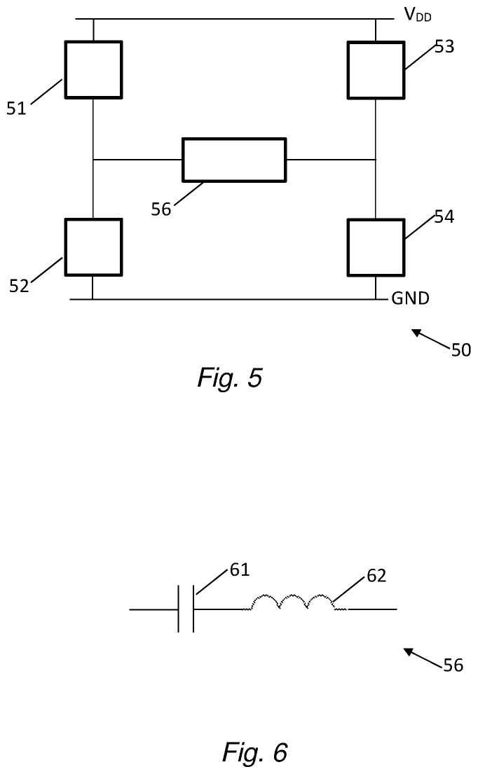

FIG. 5 is a block diagram of a circuit, indicated generally by the reference numeral 50, in accordance with an example embodiment. The circuit 50 comprises a first switch 51, a second switch 52, a third switch 53, a fourth switch 54 and a resonant circuit 56. The first to fourth switches 51 to 54 may be implemented using transistors, as discussed further below.

The first to fourth switches 51 to 54 form an H-bridge bridge circuit that may be used to apply pulses to the resonant circuit 56. Thus the first to fourth switches 51 to 54 are an example implementation of the switching arrangement 13 and the resonant circuit 56 is an example of the resonant circuit 14.

The first and second switches 51 and 52 form a first limb of the bridge circuit and the third and fourth switches 53 and 54 form a second limb. More specifically, the first switch 51 can selectively provide a connection between a first power source (labelled V_{DD} in FIG. 5) and a first connection point, the second switch 52 can selectively provide a connection between the first connection point and ground, the third switch 53 can selectively provide a connection between the first power source and a second connection point and the fourth switch 54 can selectively provide a connection between the second connection point and ground. The resonant circuit 56 is provided between the first and second connection points.

FIG. 6 is an example implementation of the resonant circuit 56 described above. The resonant circuit 56 comprise a series connection of a capacitor 61 and an inductor 62 that may be connected between the first and second connection points of the system 50 described above. As described further below, the inductor may be used for inductively heating a susceptor (e.g. the susceptor 16 of the system 10).

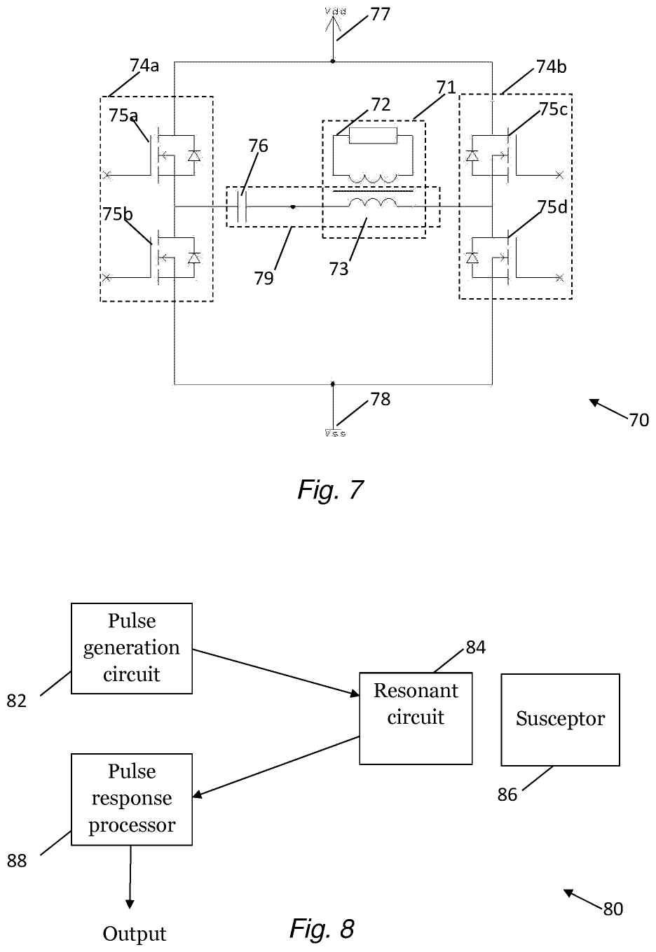

FIG. 7 is a block diagram of a circuit, indicated generally by the reference numeral 70, in accordance with an example embodiment. The circuit 70 is an example implementation of the circuit 50 described above.

The system 70 comprises a positive terminal 77 and a negative (ground) terminal 78 (that are an example implementation of the DC voltage supply 11 of the system 10 described above). The circuit 70 comprises a switching arrangement 74 (implementing the switching arrangement 13 described above), where the switching arrangement 74 comprises a bridge circuit (e.g. an H-bridge circuit, such as an FET H-bridge circuit). The switching arrangement 74 comprises a first limb 74a and a second limb 74b, where the first limb 74a and the second limb 74b are coupled by a resonant circuit 79 (which resonant circuit implements the resonant circuits 14 and 56 described above). The first limb 74a comprises switches 75a and 75b (implementing the switches 51 and 52 described above), and the second limb 74b comprises switches 75c and 75d (implementing the switches 53 and 54 described above). The switches 75a, 75b, 75c, and 75d may be transistors, such as field-effect transistors (FETs), and may receive inputs from a controller, such as the control circuit 18 of the system 10.

The resonant circuit 79 comprises a capacitor 76 and an inductive element 73 such that the resonant circuit 79 may be an LC resonant circuit. The circuit 70 further shows a susceptor equivalent circuit 72 (thereby implementing the susceptor arrangement 16). The susceptor equivalent circuit 72 comprises a resistance and an inductive element that indicate the electrical effect of an example susceptor arrangement 16. When a susceptor is present, the susceptor arrangement 72 and the inductive element 73 may act as a transformer 71. Transformer 71 may produce a varying magnetic field such that the susceptor is heated when the circuit 70 receives power. During a heating operation, in which the susceptor arrangement 16 is heated by the inductive arrangement, the switching arrangement 74 is driven (e.g., by control circuit 18) such that each of the first and second branches are coupled in turn such that an alternating current is passed through the resonant circuit 79. The resonant circuit 79 will have a resonant frequency, which is based in part on the susceptor arrangement 16, and the control circuit 18 may be configured to control the switching arrangement 74 to switch at the resonance frequency or a frequency close to the resonant frequency. Driving the switching circuit at or close to resonance helps improve efficiency and reduces the energy being lost to the switching elements (which causes unnecessary heating of the switching elements). In an example in which the article 21 comprising an aluminum foil is to be heated, the switching arrangement 84 may be driven at a frequency of around 2.5 MHz. However, in other implementations, the frequency may, for example, be anywhere between 500 kHz to 4 MHz.

FIG. 8 is a block diagram of a system, indicated generally by the reference numeral 80, in accordance with an example embodiment.

The system 80 comprises a pulse generation circuit 82, a resonant circuit 84 (such as the resonant circuit 56), a susceptor 86 (such as the susceptor 16) and a pulse response processor 88. The pulse generation circuit 82 and the pulse response processor 84 may be implemented as part of the control circuit 18 of the system 10.

The pulse generation circuit 82 may be implemented using the switching arrangements of the systems 50 and 70 described above in order to generate a pulse (e.g. a pulse edge) by switching between positive and negative voltage sources.

The pulse response processor 88 may determine one or more performance metrics (or characteristics) of the resonant circuit 84 and the susceptor 86 based on the pulse response. Such performance metrics include properties of an article (such as the removable article 21), presence or absence of such an article, type of article, temperature of operation etc.

The pulse response obtained at the pulse response processor 88 may be noisy. Although many sources of noise are possible, one source of noise is differences in timings of switches of the pulse generation circuit 82. A low pass filter function may be provided to seek to reduce such noise.

In some example embodiments, one of switches 52 and 54 (or one of the transistors 75b and 75d) may be permanently on such that one side of the resonant circuit 56 is connected to ground. This results in a low pass filter effect that can reduce noise in the pulse response.

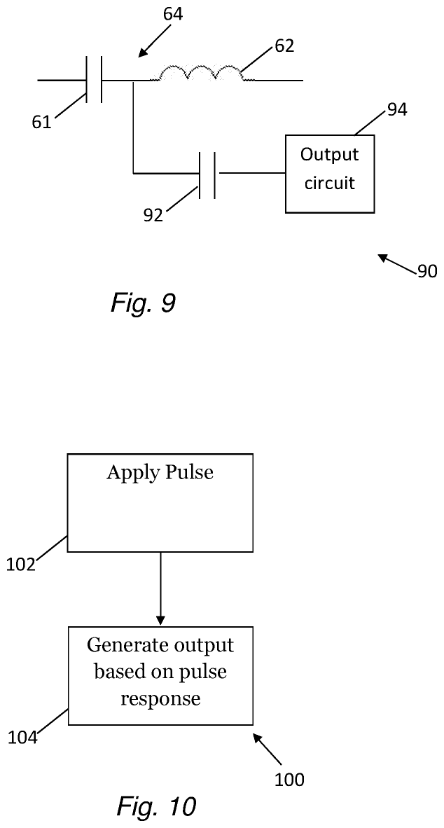

FIG. 9 is a block diagram of a circuit, indicated generally by the reference numeral 90, in accordance with an example embodiment. The circuit 90 includes the capacitor 61 and the inductive element 62 of the resonant circuit 56 described above. An output connection point, indicated generally by the reference numeral 64, is provided between the inductive element and the capacitor of the resonant circuit. An output capacitor 92 is used to couple the output connection point 64 to an output circuit 94.

FIG. 10 is a flow chart showing an algorithm, indicated generally by the reference numeral 100, in accordance with an example embodiment. The algorithm 100 shows an example use of the system 80.

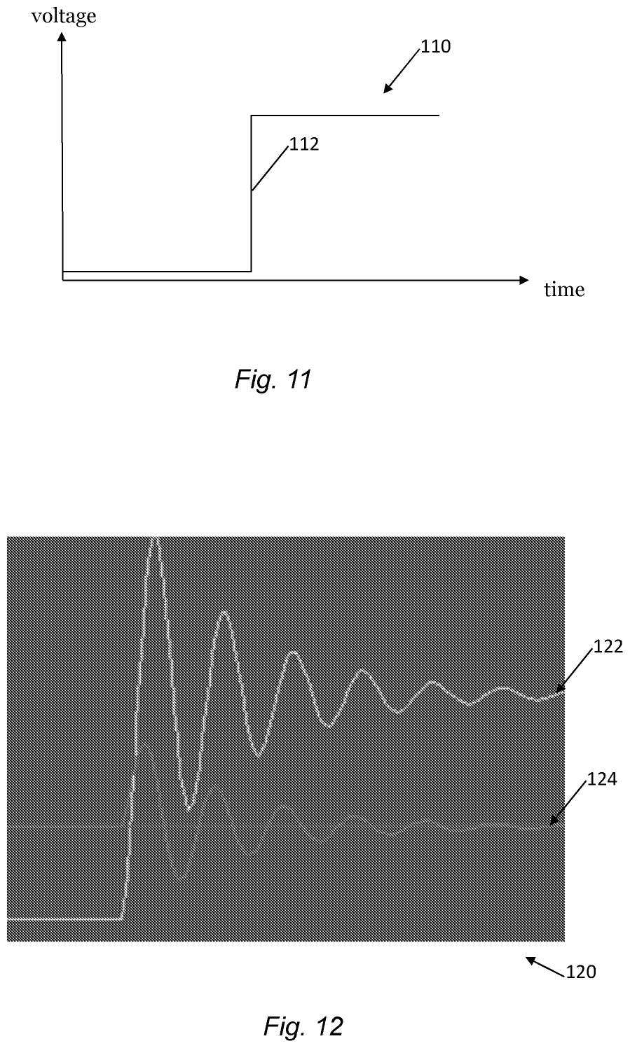

The algorithm 100 starts at operation 102 where a pulse edge (generated by the pulse generation circuit 82) is applied to the resonant circuit 84. FIG. 11 is a plot showing an example pulse 110 (including a rising pulse edge 112) that might be applied in the operation 102.

The pulse 110 may be applied to the resonant circuit 84. Alternatively, in systems having multiple inductive elements (such as non-combustible aerosol arrangement 20 described above with reference to FIGS. 2 and 3), the pulse generation circuit 82 may select one of a plurality of resonant circuits, each resonant circuit comprising an inductive element for inductively heating a susceptor and a capacitor, wherein the applied pulse induces an pulse response between the capacitor and the inductive element of the selected resonant circuit.

At operation 104, an output is generated (by the pulse response processor 88) based on a pulse response that is generated in response to the pulse applied in operation 102. That pulse response may be output of the output circuit 94.

FIG. 12 is a plot, indicated generally by the reference numeral 120, showing an example pulse response 122 that might be generated at the connection point 64 between the capacitor 61 and the inductor 62 of the resonant circuit 64 in response to the pulse 110. As shown in FIG. 12, the pulse response 122 may take the form of a ringing resonance that is generated in response to the pulse edge. The pulse response is a result of charge bouncing between the inductor(s) and capacitor of the resonant circuit 56. In one arrangement, no heating of the susceptor is caused as a result. That is, the temperature of the susceptor remains substantially constant (e.g., within ±1° C. or ±0.1° C. of the temperature prior to applying the pulse).

The plot 120 shows a second pulse response 124 that might be generated by the output circuit 94. The second pulse response 124 may be the pulse provided to the pulse response processor 88.

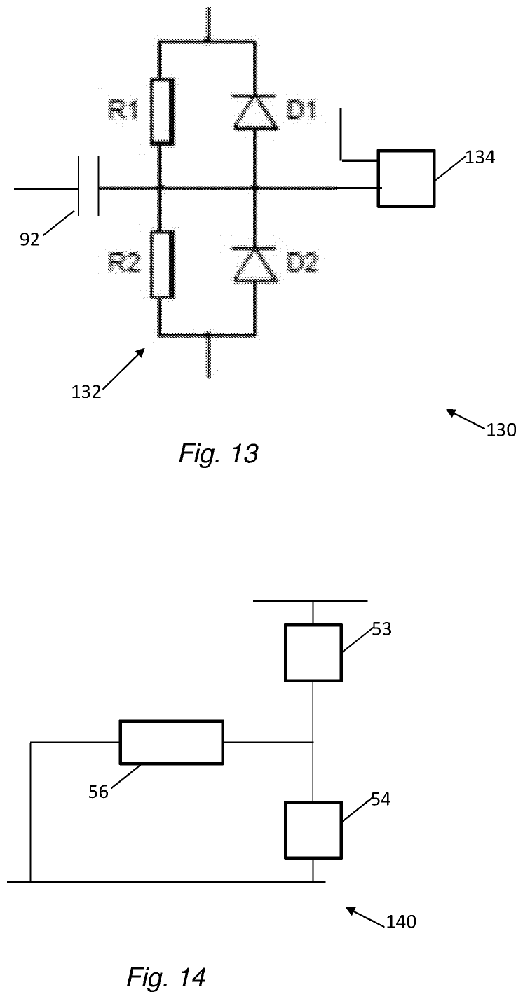

FIG. 13 is a block diagram of a circuit, indicated generally by the reference numeral 130, in accordance with an example embodiment. The circuit 130 is an example implementation of the output circuit 94 described above.

The circuit comprises the output capacitor 92 that, as described above, is used to couple the output connection point 64 to the output circuit 94. The circuit 130 also comprises a signal conditioning circuit 132 and a comparator 134. The signal conditioning circuit 132 comprises a first limb comprising a first resistor R1 and a second resistor R2 in parallel with a second limb comprising a first diode D1 and a second diode D2. The signal conditioning circuit may be used to implement a DC voltage adjustment function.

The signal conditioning circuit 130 has at least three purposes. The first is to provide protection from voltage spikes. This is achieved by the stacked diodes and a resistor (not shown) between the mid-points of the diodes and the output. The second is to provide signal decoupling; this is the purpose of the output capacitor 92 described above. The third is to set the offset voltage of a pulse response at the output connection point 64.

The output of the signal conditioning circuit 130 may be provided to the comparator 134. The offset voltage set by the signaling conditioning circuit may be configured to match that of the input of said comparator to ensure that the comparator triggers at the mid-point of the pulse response. This is achieved using the resistors R1 and R2.

At least some of the properties of the pulse response (such as frequency and/or decay rate of the pulse response) provide information regarding the system to which the pulse is applied. Thus, the system 80 can be used to determine one or more properties of the system to which the pulse is applied. For example one or more performance properties, such as fault conditions, properties of an inserted article 21, presence or absence of such an article, whether the article 21 is genuine, temperature of operation etc., can be determined based on output signal derived from a pulse response.

As described above, the pulse response obtained at the pulse response processor 88 may be noisy. One approach to reducing the noise is for one of the switches 52 and 54 (or one of the transistors 75b and 75d) to be permanently on (i.e. conducting), such that one side of the resonant circuit 56 is connected to ground. Another approach, as shown in FIG. 14, is to replace one of those switches with a permanent connection to ground.

FIG. 14 is a block diagram of a circuit, indicated generally by the reference numeral 140, in accordance with an example embodiment. The circuit 140 comprises the third switch 53, the fourth switch 54 and the resonant circuit 56 of the circuit 50 described above. In addition, the first connection point (between the first switch 51 and the resonant circuit 56) is connected to ground. Thus, the second switch 52 of the circuit 50 is replaced with a permanent connection to ground.

The circuit 50 described above provides a full-bridge circuit for driving the resonant circuit 56. The circuit 140 provides a half-bridge circuit for driving the resonant circuit 56. For example, the circuit 50 may be particularly suitable for providing pulses for driving the resonant circuit for inductively heating a susceptor and the circuit 140 may be particularly suitable for providing pulse edges for generating pulse responses from the resonant circuit for analysis (e.g. measurement).

In some example embodiments, a bridge circuit can be controlled to operate in either a measurement mode (in which pulse edges can be applied to a resonant circuit) or a heating mode (in which pulses can be applied to the resonant circuit for inductively heating a susceptor). As described further below, in the measurement mode, the bridge circuit may be configured in a half-bridge mode including the low pass filtering arrangement described above (e.g. using the circuit 140 or some similar configuration) and, in the heating mode, the bridge circuit may be configured in a full-bridge mode (e.g. using the circuit 50 or some similar configuration).

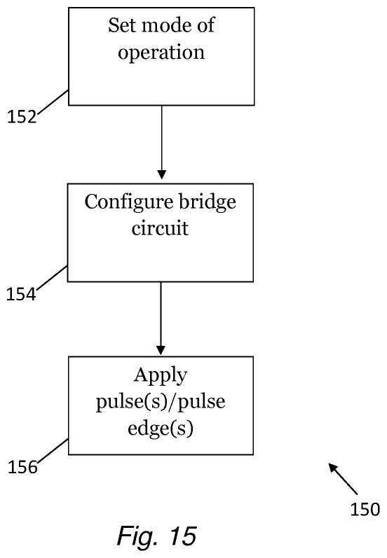

FIG. 15 is a flow chart showing an algorithm, indicated generally by the reference numeral 150, in accordance with an example embodiment.

The algorithm 150 starts at operation 152, where a selection is made between a measurement mode of operation and a heating mode of operation of a resonant circuit (such as the resonant circuit 56 described above).

In operation 154, a bridge circuit is configured depending on the mode of operation selected in the operation 152. Specifically, the bridge circuit is configured in a half-bridge mode in the event that the measurement mode is selected and the bridge circuit is configured in a full-bridge mode in the event that the heating mode of operation is selected.

As described above, the bridge circuit comprises a first limb having the first connection point, a second limb having the second connection point, a third transistor connected between a first power source and the second connection point and the fourth transistor connected between the second connection point and ground.

In the half-bridge mode, the bridge circuit is configured such that the first connection point is connected to ground, such that the low pass filtering arrangement described above in enabled (as in the circuit 140 described above). As discussed above, the first limb may comprise a second transistor connected between the first connection point and ground. Thus, configuring the bridge circuit in the half-bridge mode may comprises switching a second transistor (of the first limb) into a conducting state while alternately switching the third and fourth transistors (of the second limb).

More specifically, the first limb may have a first transistor connected between the first power source and the first connection point and a second transistor connected between the first connection point and ground (as in the circuit 50 described above), wherein the first and second transistors of the first limb (and the third and fourth transistors of the second limb) are switched to implement the full-bridge mode and only the transistors of the second limb are switched during the half-bridge mode

At operation 156, one or more pulses or pulse edges are applied to the resonant circuit using the configured bridge circuit. In the measurement mode of operation, one or more pulse edges are applied to induce a pulse response between the capacitor and the inductive element of the resonant circuit, wherein the pulse response has a resonant frequency (which resonant frequency may be a measurement). In the heating mode of operation, one or more pulses to the inductive element for inductively heating a susceptor in the heating mode of operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the disclosure. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An apparatus comprising:
a bridge circuit for applying one or more pulse edges to a resonant circuit, the bridge circuit having a first limb in which a first connection point is connected to ground, and a second limb having a third transistor connected between a first power source and a second connection point and a fourth transistor connected between the second connection point and ground,
wherein the resonant circuit comprises an inductive element and a capacitor connected in series between the first connection point and the second connection point, wherein the inductive element is for inductively heating a susceptor, wherein each applied pulse edge induces a pulse response between the capacitor and the inductive element of the resonant circuit, and wherein the pulse response has a resonant frequency.

2. The apparatus as claimed in claim 1, wherein the bridge circuit is an H-bridge circuit.

3. The apparatus as claimed in claim 1, wherein the first limb of the bridge circuit comprises a first transistor connected between the first power source and the first connection point.

4. The apparatus as claimed in claim 1, wherein the first limb of the bridge circuit comprises a second transistor connected between the first connection point and ground.

5. The apparatus as claimed in claim 1, wherein the capacitor of the resonant circuit is connected to the first connection point and the inductive element of the resonant circuit is connected to the second connection point.

6. The apparatus as claimed in claim 1, further comprising an output connection point between the inductive element and the capacitor of the resonant circuit.

7. The apparatus as claimed in claim 6, further comprising an output circuit coupled to the output connection point between the inductive element and the capacitor of the resonant circuit.

8. The apparatus as claimed in claim 7, wherein the output circuit and the output connection point are coupled using an output capacitor.

9. The apparatus as claimed in claim 6, wherein the output circuit is a DC voltage adjustment circuit.

10. The apparatus as claimed in claim 6, wherein the output circuit comprises a comparator.

11. The apparatus as claimed in claim 6, wherein the capacitor of the resonant circuit is provided between the first connection point and the output connection point and the inductive element of the resonant circuit is provided between the second connection point and the output connection point.

12. An apparatus comprising:
an H-bridge circuit for applying one or more pulse edges to a resonant circuit, the H-bridge circuit having a first limb having a first transistor connected between a first power source and a first connection point and a second transistor connected between the first connection point and ground, and a second limb having a third transistor connected between the first power source and a second connection point and a fourth transistor connected between the second connection point and ground,
wherein the resonant circuit comprises an inductive element and a capacitor connected in series between the first connection point and the second connection point, wherein the inductive element is for inductively heating a susceptor, wherein each applied pulse edge induces a pulse response between the capacitor and the inductive element of the resonant circuit, and wherein the pulse response has a resonant frequency;
an output circuit for providing an output signal dependent on one or more properties of the pulse response; and
an output capacitor connected between an output connection point between the inductive element and the capacitor of the resonant circuit and an input of the output circuit.

13. The apparatus as claimed in claim 12, wherein the capacitor of the resonant circuit is provided between the first connection point and the output connection point and the inductive element of the resonant circuit is provided between the second connection point and the output connection point.

14. The apparatus as claimed in claim 12, wherein the output circuit comprises a DC voltage adjustment circuit.

15. The apparatus as claimed in claim 12, wherein the output circuit comprises a comparator.

16. The apparatus as claimed in claim 1, wherein the apparatus is operable in a heating mode of operation in which one or more pulses are applied to the inductive element for inductively heating the susceptor.

17. The apparatus as claimed in claim 1, further comprising the resonant circuit.

18. A method comprising:
selecting between a measurement mode and a heating mode of operation of a resonant circuit, wherein the resonant circuit comprises an inductive element and a capacitor connected in series between a first connection point and a second connection point of a bridge circuit; and
configuring the bridge circuit in a half-bridge mode when the measurement mode is selected and configuring the bridge circuit in a full-bridge mode when the heating mode of operation is selected, wherein the bridge circuit comprises a first limb having the first connection point, a second limb having the second connection point, a third transistor connected between a first power source and the second connection point and a fourth transistor connected between the second connection point and ground.

19. The method as claimed in claim 18, wherein configuring the bridge circuit in the half-bridge mode comprises configuring the bridge circuit such that the first connection point is connected to ground.

20. The method as claimed in claim 18, wherein the first limb comprises a second transistor connected between the first connection point and ground, and wherein configuring the bridge circuit in the half-bridge mode comprises switching the second transistor into a conducting state.

21. The method as claimed in claim 18, wherein the first limb comprises a first transistor connected between the first power source and the first connection point and a second transistor connected between the first connection point and ground.

22. The method as claimed in claim 18, further comprising applying one or more pulse edges to the resonant circuit in the measurement mode of operation, wherein each applied pulse edge induces a pulse response between the capacitor and the inductive element of the resonant circuit, wherein the pulse response has a resonant frequency.

23. The method as claimed in claim 18, further comprising applying one or more pulses to the inductive element for inductively heating a susceptor in the heating mode of operation.

24. A non-combustible aerosol generating device comprising the apparatus as claimed in claim 1.

25. The non-combustible aerosol generating device as claimed in claim 24, wherein the aerosol generating device is configured to receive a removable article comprising an aerosol generating material.

26. The non-combustible aerosol generating device as claimed in claim 25, wherein the aerosol generating material comprises an aerosol generating substrate and an aerosol forming material.

27. The non-combustible aerosol generating device as claimed in claim 25, wherein the removable article includes a susceptor arrangement.

28. A kit of parts comprising an article for use in a non-combustible aerosol generating system, wherein the non-combustible aerosol generating system comprises the apparatus as claimed in claim 1.

29. The kit of parts as claimed in claim 28, wherein the article is a removable article comprising an aerosol generating material.
